(19) United States
(12) Patent Application Publication
(10) Pub. No.: US 2007/0258248 A1
(43) Pub. Date: Nov. 8, 2007

(54) Lighted lens housing for jewelers loupe

(76) Inventor: Jerry Ronald Duhe JR., Houston, TX (US)

Correspondence Address: JERRY R. DUHE JR, P.O. BOX 670115, HOUSTON, TX, 77267, US

(21) Appl. No.: 11/799,322

(22) Filed: May 1, 2007

Related U.S. Application Data
(60) Provisional application No. 60/797,588, filed on May 4, 2006.

(51) Int. Cl. F21V 15/00

(52) U.S. Cl. 362/362

(57) ABSTRACT

A lighted lens housing is provided, having led(s) placed in progression around a lens opening. The light generated from led(s) is directed to a desired focal point by means of deflector ring found adjacent the outer edge of led(s). A central lens channel is provided for the insertion and placement of a desired lens. A threaded opening at one end of lens channel for attachment to a typical jewelers loupe. Electrical power is provided by button cell battery.

### CROSS-REFERENCE TO RELATED APPLICATIONS

The present application is based on, and claims priority from, provisional application Ser. No. 60/797588, Filed May 4, 2006, entitled “LIGHTED LENS HOUSING FOR JEWELLERS LOUPE”, which is incorporated herein in it's entirety by reference.

### STATEMENT REGARDING FEDERALLY SPONSORED RESEARCH OR DEVELOPMENT

N/A

### REFERENCE TO APPENDIX

N/A

### BACKGROUND OF THE INVENTION

1. Field of the Invention

The present invention relates generally to a lens housing and more specifically to a lens housing which incorporates illumination with intent to provide a 360-degree use of light in conjunction with an inserted magnification lens from a Jewelers loupe and attachment to the same.

2. Description of the Related Art

Illumination in conjunction with magnification has always been an issue since the inception of the magnification lens. The limitations imposed by daylight hours and available light, have encouraged those concerned to seek alternate and more effective means of illumination. The introduction of incandescent bulbs and the like, as illumination in conjunction with an available power source has been a large contributor in dictating various parameters concerning size and application. There have been an array of hand held loupes using incandescent bulbs first, and more recently led(s) (light emitting diode(s) to introduce light to the subject to be viewed. These magnifiers are normally hand held and have one led (light emitting diode) addressing one area. This of course is very limited because a large part of the viewing area goes un-addressed. Up till now no man made light sources in conjunction with a hands free jewelers loupe has been unavailable. Hands free visors utilizing magnification have been introduced with and without a light source. Those hands free visors, which are illuminated, normally have a light source in the center of the visor or at the corners, which again leave a substantial portion of the viewing area un-addressed. Up to now a typical hands free jewelers loupe has been used completely with ambient light. Because this typical jewelers loupe is to be held in place by the muscles and skin surrounding the eye, it is imperative that it be as lightweight as possible to avoid displacement. Therefore there exist a need to provide an extremely light weight illumination means which would be capable of providing a completely addressed viewing area and be used in conjunction with a typical hands free jewelers loupe.

### OBJECTS AND SUMMARY OF THE INVENTION

An object of the invention is to provide an effective illumination means for a hands free jewelers loupe.

Another object of the present invention is to provide 360 degrees of light directed at the focal point of a desired lens.

A further object of the present invention is to provide an extremely lightweight lens housing, illumination means and power source to work in conjunction with the typical jeweler's loupe and not adversely affect its ability to be held in place.

Still another object of the present invention is to reduce, if not eliminate dark spots and shadows concerning the objects being viewed and to address all areas available through the lens with illumination.

And still another object of the present invention is for its manufacture to be cost effective and to easily attach to a typical jewelers loupe while accepting a desired lens.

These objects as well as others are achieved by providing a lighted lens housing according to the present invention. A preferred embodiment of the present invention provides a lighted lens housing having a main body capable of receiving led(s) and exposing the lighted portion of the led(s) in progression around the lens opening. A light deflector ring capable of adjusting the light convergence to a desired focal point. A lens receiving channel, so that a lens from a jeweler's loupe may be installed and rest within the channel next to the exposed led(s).

A main body cover provided with a threaded opening for attachment to a typical jewelers loupe and a switching means provided with a small but effective power source.

These as well as other feature are discussed in complete detail in the foregoing description and drawings.

### BRIEF DESCRIPTION OF THE SEVERAL VIEWS OF THE DRAWING

FIG. 1 shows a side cut-away view of a preferred embodiment in relation to a typical jewelers loupe and Lens.

FIG. 1A reveals a side view and rear interior details of the preferred embodiment.

FIG. 2 shows an interior and exterior view of a rear cover.

FIG. 2A shows a side cut-away view of a lighted housing with an exterior view of an installed lighted housing in conjunction with a typical jewelers loupe.

FIG. 3 illustrates a cut-away side view of a lighted housing in relation to a side view the housing installed on a typical jewelers loupe.

FIG. 3A shows interior details of an 8 led lighted housing and rear view of back.

FIG. 4 reveals the inside of the back or lower housing.

FIG. 4A is a fragmentary view revealing cut-away of a lighted housing in relation to a single lens jewelers loupe.

FIG. 5 illustrates a frontal view of a typical lighted housing.

FIG. 5A shows a perspective view of a lighted housing.

FIG. 6 shows an exploded view revealing a method of assembly of a lighted housing.

FIG. 7 shows a side view of a lighted housing together with a cut away of a rear cover.

FIGS. 8, 8A, 8B, 8C, 8D, 8E, 8F, 8G, and 8H, illustrates a variation of lighted housings shown in cut-away with various diversifications of detail.

FIGS. 9 and 9A shows a cut-away side view and cut-away rear views of a single led lighted housing.

FIG. 9B reveals a cut away of a rear portion of a single led housing showing an off center lens channel.

FIG. 10 shows interior details of the lighted housing with a variation of battery cell and led placement.

FIG. 11 shows a cut-away side view with a variation of modified led(s).

FIG. 11A illustrates an assortment of side views of modified led(s).

FIG. 12 shows a side, interior and rear view and modified details of back and lower housing.

### DETAILED DESCRIPTION OF THE INVENTION

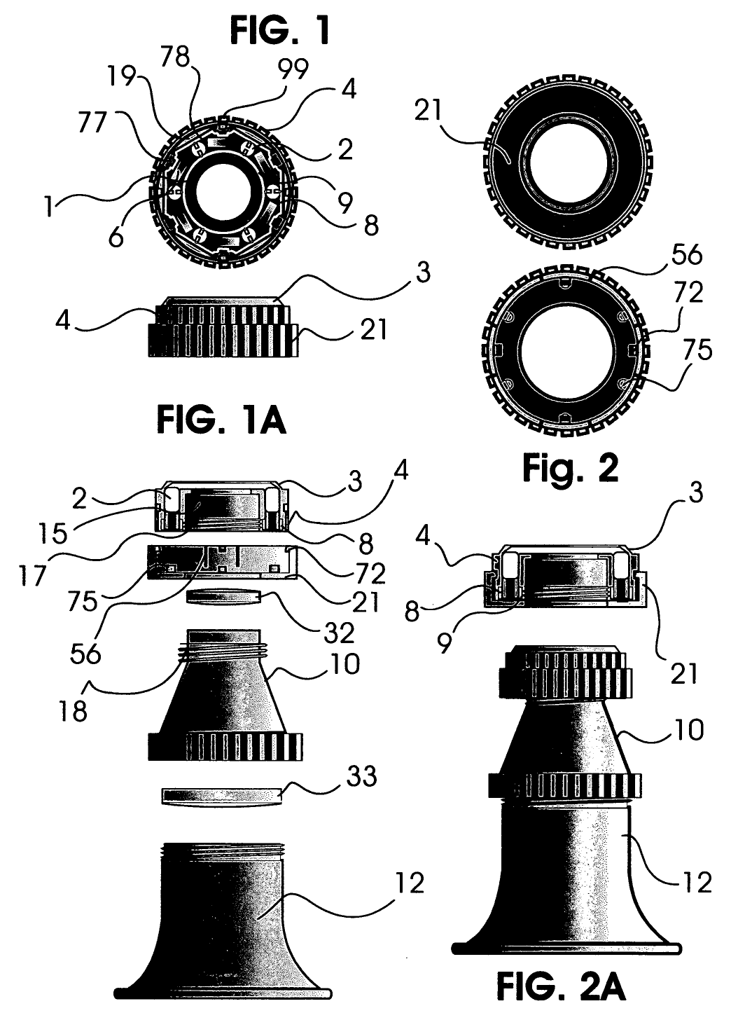

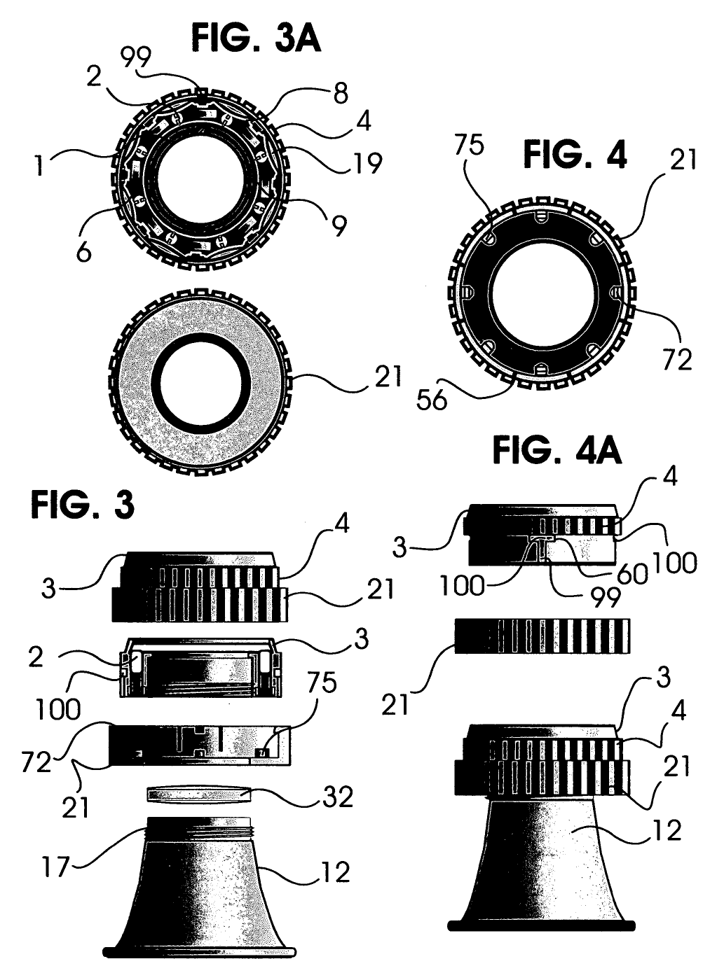

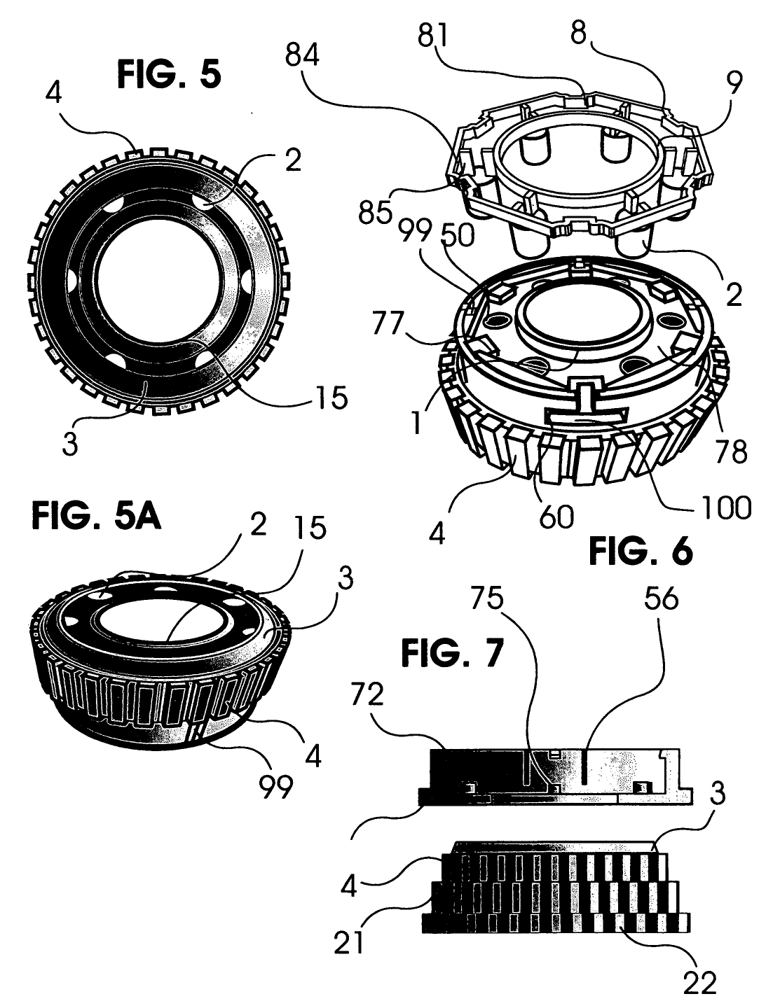

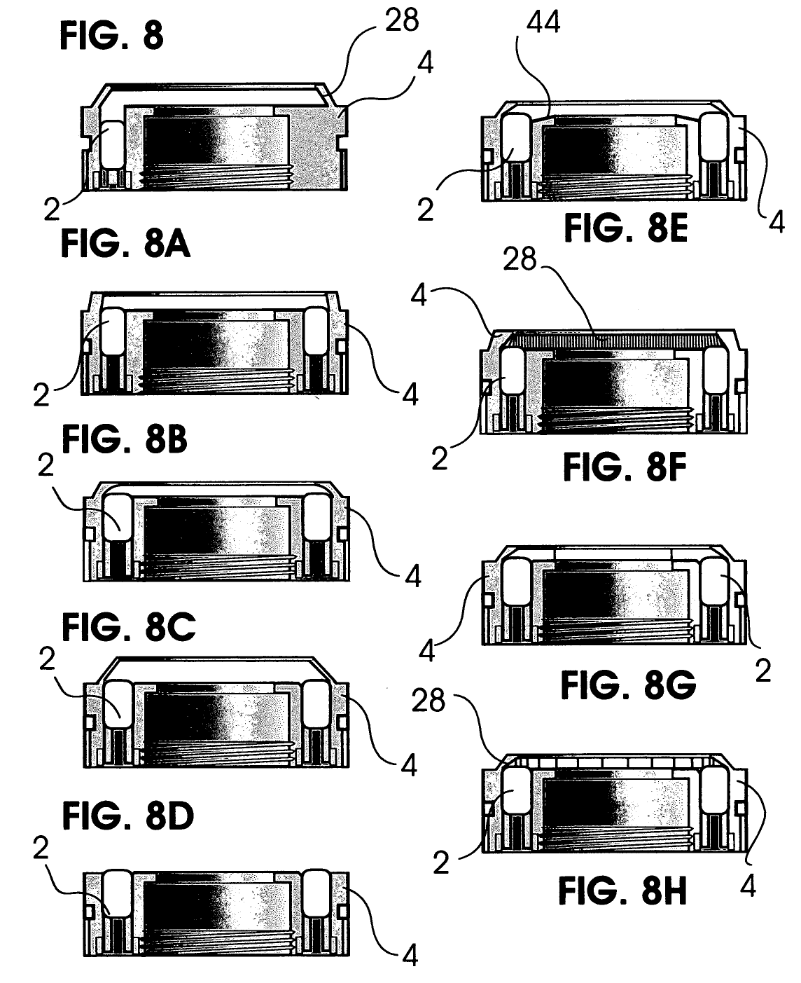

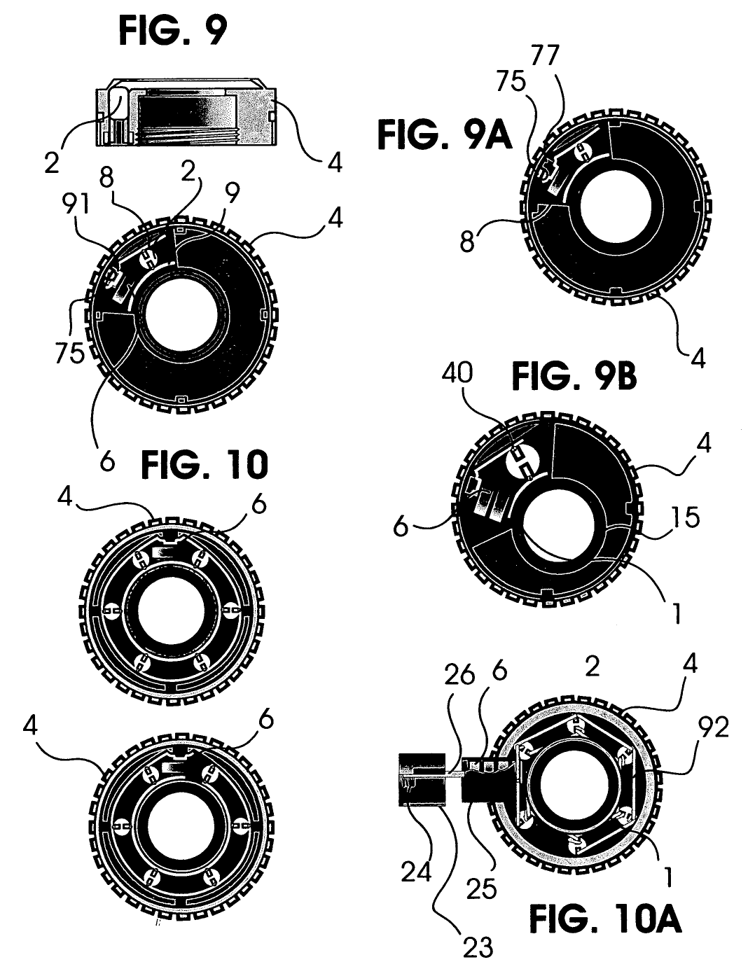

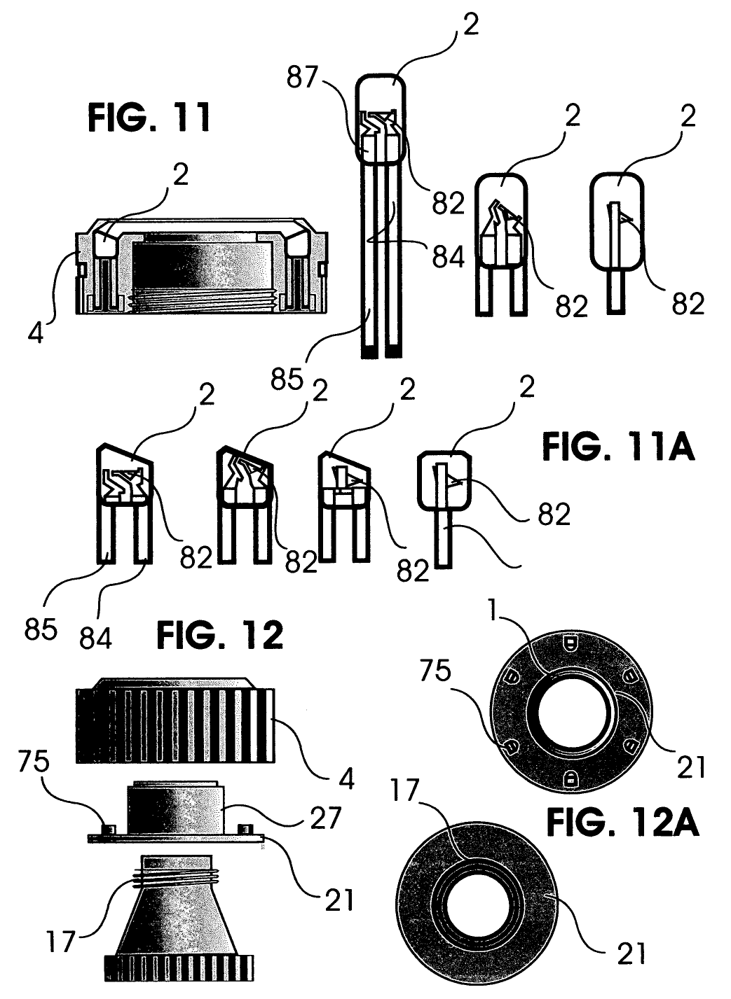

The foregoing is a description in detail of the preferred embodiment of the present invention. Referring to FIG. 1 there is shown in the drawings housing 4 of which is comprised of two parts: upper housing 4 and the back and lower housing 21, both of which would be fabricated of a light weight suitable plastic, resin or appropriate material for housing a light source and compatible with circuitry. The upper housing 4 is provided with chamber(s) 50, which are adapted to receive led(s) (light emitting diode(s) 2 as best seen in FIG. 6, when multiple led(s) (light emitting diode(s) are employed, chamber(s) 50 are spaced apart. Also seen in FIG. 1 within upper housing 4 and better seen in FIG. 6, is recess 78, which is fashion to receive positive contact member 9 and negative contact member 8 when fully assembled. Positive contact member 9 and negative contact member 8 would be made of a suitable material for conducting electrical current and also allow for a modicum amount of flexibility, (it must also be stated that these contacts both 9 and 8 and they're placement are part of typical circuitry). The upper housing 4 further provides lens channel 15 for the receiving and placement of a desired lens 32 as seen in FIG. 1A, the upper housing 4 further utilizes terminal stop platforms 77 for the purpose of holding the installed battery cell 6 in a biased position adjacent positive contact member 9 and to cooperate with movable instruction member 75 as best seen in FIG. 10. In FIG. 1A upper housing 4 is shown with light deflection ring 3 as integral part formed in unison with housing 4 (ring 3 will be discussed in further detail later). Referring to FIG. 1A upper housing 4 and lower housing 21 are shown in cross section revealing the placement of the led(s) 2 in cooperation with lens receiving channel 15. Lower housing 21 as seen in FIG. 1A, utilizes movement slots 56 which allow outward movement of anchors 72 with intent to rest within selection channel 100 as best seen in FIG. 2A, after which would allow lower housing 21 to move laterally in rotation acting as switch to complete the circuit thereby urging the led(s) 2 to light. FIG. 1A further shows threads 17 of upper housing 4 adapted to communicate with threads 18 of lens spacer 10 of the typical jewelers loupe. Referring to FIG. 1A there is shown a typical two-lens jewelers loupe in sections, eye piece 12, first lens 33, lens spacer 10 and second lens 32. FIG. 2 also shows a topical view revealing the inside of lower housing 21 with instruction members 75 and anchors 72 visible, also shown here are movement slots 56 in relation to anchors 72. FIG. 2A reveals a cross section of upper housing 4 and lower housing 21 after adjoinment with anchors 72 securely resting within selection channels 100 awaiting lateral rotation. This lateral movement is best achieved by employing the serrated exterior of upper housing 4 affording a more sufficient grip, which would assist in accomplishing the desired movement. The lateral movement is restricted by the terminal stops 60 of selection channel 100 as best seen if FIGS. 4A and 6. Once again FIG. 2A reveals a side view of a conjoined upper housing 4 and lower housing 21 resulting in a fully assembled lighted housing in cooperation with the typical two-lens jewelers loupe. Referring to FIG. 3 and FIG. 4A there is shown the present invention adapted to respond to a single lens jewelers loupe. In FIG. 3A is shown the upper body 4 fashioned with eight leds 2 instead of the six as in FIG. 1. Also seen in FIG. 3A is the back of lower housing 21. FIG. 3A shows a cross sectional view of upper housing 4 and lower housing 21 similar to that seen in FIG. 1A. FIG. 3 further shows lens 32 and eyepiece 12 of a typical single lens jeweler's loupe and relation of assembly with lighted housing. FIG. 4 shows the interior details of lower housing 21 with instruction members 75 in number to cooperate with an eight led 2 assembly. FIG. 4A reveals the exterior side portion of the upper housing 4 revealing entrance 99 of selection channel 100 and its position. Again FIG. 4A showing the lighted housing fully assembled and in cooperation with the typical single lens jewelers loupe. Referring to FIG. 5 there is shown a typical frontal view of the lighted housing revealing approximate placement of six led(s) 2 in correspondence with an installed lens 32 and light deflection ring 3. FIG. 5A shows upper housing 4 in perspective view revealing placement of entrance 99 of selection channel 100. FIG. 6 shows in perspective the relationship of the led 2 lamp assembly and recess 78 and with upper housing 4 and led chamber(s) 50, the led lamp assembly consist of the leds 2, a positive contact 9 and the negative contact 8, the leads of the led(s) would of course be attached in succession (when more than one were used) to contacts 9 and 8 by means of solder 40 (as seen in FIG. 9B) or the like, it must also be noted that the typical lengthy leads of the led(s) as seen in FIG. 11 could also serve as contacts 9 and 8 as best seen in FIG. 10A by cutting and crimping them together, there by also eliminating the need for customary soldering. FIG. 6 also shows instruction platform 77 and entrance 99 of selection channel 100. It must also be mentioned at this point that selection platform 77 is adapted to cooperate with the back of battery cell 6 to securely hold it in a biased fashion against the flat of positive contact member 9, this platform 77 also acts in cooperation with instruction member 75 to limit its movement resulting in positive terminal stops both inward and in a lateral fashion. Lower housing 21 shown here in FIG. 7 is slightly modified over the previous to include secondary grip collar 22 as means to facilitate disassembly in the process of battery cell 6 replacement, this modification can also aid in the manual rotation during the on and off process. Referring to FIG. 8 there is shown an array of upper housing(s) 4 with variations in light deflection rings 3 and the placement of led(s) 2. Also in FIG. 8 is shown a single led housing 4 with the led 2 placed lower than in previous FIGS. 1A, 3A and FIG. 2. The actual placement of the led 2 is a matter concerned directly with a particular desired result in lighting effect. FIG. 8A shows a more straight light deflector ring 3, this is for use with lower powers of magnification, because the led light focal point would need to converge at a greater distance from lens 32 thereby needing a lesser angle of redirection. The more powerful the loupe or magnification, the closer outer lens 32 needs to be in relation to the object being studied, therefore, the greater the angle of deflection. FIGS. 8B, 8C, 8E, 8G and 8H show a much sharper angle in the light deflection ring 3 because the light convergence needs to be much closer in front of the outer lens 32 in order to adequately illuminate the object being studied. Now go to FIG. 8D, There is shown the complete lack of light deflection ring 3, this is because of a low magnification loupe, which would mean that the object being view would be at a substantial distance from lens 32. FIG. 8B shows a slight curvature of inner surface 28 of light deflection ring 3. This of course as stated before would be for accomplishing a desired light pattern, diffusement/or effect. Again with FIGS. 8F, 8G, and 8H showing a pattern in this inner face 28 of reflection ring 3 in order again to obtain a particular effect. It must also be mentioned that this inner face 28 can be a natural color and reflect and adequate amount of light, but as this area is modified by color such as white, silver, chrome, or another highly reflectant shade this can greatly affect the amount of light reflected, thereby magnifying the available light and achieving a variation of significant results. This modification is not only restricted to the inner surface of deflection ring 3, but can also include the exterior surface 44 of inner ring 1 which is found adjacent the installed lens 32 as best seen in FIG. 8E. Referring to FIG. 9 there is shown a single led housing 4 revealing the cooperation of battery cell 6 with positive contact member 9 and the placement and cooperation of instruction member 75 with shaped flat 91 of negative contact member 8 awaiting contact with the rear negative surface of battery cell 6 upon lateral rotation of instruction member 75 which would occur naturally during rotation of lower housing 21. FIG. 9A shows contact being made with the rear surface of the negative side of battery cell 6 and shaped flat 91 of negative contact member 8 thereby completing the circuit and adding power to led(s) 2 resulting in light. This contact is put in play by the progressional placement of instruction member 75 during rotation of lower housing 21 thereby urging this contact and completing the circuit. FIG. 9B also shows a single led housing 4 utilizing two-battery cells 6 in succession. FIG. 9B further reveals an off center lens placement ring 15 which would allow for a larger led and a larger power source internally without having to attach in an external fashion as seen in FIG. 10A, but would of course require modification of lower housing 21 in order to work as intended. FIGS. 9B and 10 shows a variation of led(s) 2 with battery cell 6 placement, which can determine the number of battery cell 6 needed and the life span of the same, all shown in parallel circuit with slight differences. FIG. 10A further shows the aforementioned external battery-holding chamber 25 with switch cap 23 utilizing spring 24 and selector contact 26 instead of the lateral movement of lower housing 21 and instruction members 75. FIG. 11 shows a cross sectional view of upper housing 4 utilizing a slightly modified led 2, this could be employed for two main reasons, one of which as seen in FIG. 11A would get reflector bowl 82 of the led 2 closer to the surface of the reflector ring 3 and the exterior of the lens 32, and secondly this modification could assist in cooperation with deflector ring 3 to afford a greater level of focal point convergence. FIG. 11 further shows a typical led 2 with typical lead frame assembly 87 with typical lengthy leads (cathode 84 and anode 85). FIG. 11A shows a variation of modified led(s) 2 which could be employed if the application warranted it, and if it were deemed necessary to modify the led(s) 2 from the norm in order to create a better or desired result. Referring back to FIG. 11 the typical led 2 consist of cathode 84 and anode 85, reflector bowl 82 and lead frame 87. In FIG. 11A the modifications vary from concerns with the shape of the exterior epoxy and the angle of reflection bowl 82, if this angle were changed it could drastically affect the angle or shape of the light deflection ring 3. FIG. 12 shows a slightly modified lighted lens housing 4 with lower body 21 affixing to secondary lens spacer 10 by means of threads 17 instead of upper housing 4 attaching directly to secondary lens spacer 10 as seen earlier in FIGS. 1 and 3. In this FIG. 12 lower housing 21 has an integral internal lens spacer 27 to hold an installed lens 32 in place and should snap onto upper housing 4 similarly as before, allowing for lateral rotation thereby acting as a switch. FIG. 12A shows the interior details of lower housing 21 revealing a similar placement of instruction members 75. FIG. 12A also reveals the rear view of lower housing 21 showing the placement of threads 17 for attachment to secondary lens spacer 10. The aforementioned description of the preferred embodiment is not intended to be exhaustive or to limit the invention to the precise form disclosed. It is apparent that the above described invention could be affixed to and work in conjunction with a desired microscope and magnification lens, used in cooperation with a camera lens, combined with a variety of surgical and dental tools, used with lasers, incorporated in hand held magnifiers and the like. Therefore it would be obvious to one skilled in the art that certain modification of descriptions, the combining of parts, changes in assembly, changing of geometrical shapes, size and/or proportions and minor details of construction with the intent for accomplishing the same or similar action in conjunction with an array of application, all of which could be accomplished and still remain in the scope and the spirit of the present invention without sacrificing any of the advantages of the invention.

1) A lens housing comprising;
a body,
an illumination means,
a lens receiving channel,
a means for attachment to a typical jewelers loupe.

2) The lens housing of claim 1, wherein said illumination means is a led,

3) The lens housing of claim 2, wherein, said illumination means is a plurality.

4) The lens housing of claim 1, wherein said body is provided with a light deflection means for redirecting the light rays from said illumination means to a desired focal point.

5) A lens housing for receiving a lens for magnification, comprising;
a body,
at least one led,
a light deflection means for redirecting light rays from said led to a focal point and,
a means to provide electrical power and,
a means to affix.

6) The lens housing of claim 5 wherein said body is provided with a lens receiving channel.

7) The lens housing of claim 6 wherein, said lens receiving channel has a first end and a second end.

8) The lens housing of claim 7 wherein, said second end of said lens receiving channel has means to affix to a jewelers loupe.

9) The lens housing of claim 5, wherein said at least one led is a plurality.

10) A lens housing for attachment to a jewelers loupe comprising;
a body provided with recesses and at least one chamber and,
a means for illumination and,
a lens channel and,
a means to provide electrical current to said illumination means.

11) The lens housing of claim 10, wherein said lens channel has a first end and a second end.

12) The lens housing of claim 11, wherein said means for illumination is adjacent said first end of said lens channel.

13) The lens housing of claim 12, wherein said means for illumination is a plurality of led(s) spaced apart.

14) The lens housing of claim 11, wherein said second end of said lens channel has an attachment means to affix to a jewelers loupe.

15) The lens housing of claim 10, further comprising a means for deflecting light rays produced by said illumination means to a desired focal point.

16) The Lens housing of claim 5, wherein the light deflection means is annular.
